(19) United States
(12) Patent Application Publication
(10) Pub. No.: US 2010/0177997 A1
(43) Pub. Date: Jul. 15, 2010

(54) RADIAL FOIL BEARING WITH SEALING FUNCTION

(75) Inventor: Heon Seok Lee, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Kturbo Inc., Cheongwon-gun, Chungbuk (KR)

(21) Appl. No.: 12/664,322

(22) PCT Filed: Jun. 12, 2007
(86) PCT No.: PCT/KR07/02794

§ 371 Date: Dec. 11, 2009

(51) Int. Cl. F16C 33/00

(52) U.S. Cl. 384/91

(57) ABSTRACT

The present invention relates to a radial foil bearing including: a top foil having the following relationship: t≧0.1·D^{0.33}, where t designates a thickness (mm) and D designates a diameter (mm) of a shaft; and a stopper adapted to prevent the escape of parts of the bearing and to block the gaps formed between adjacent bumps.

### TECHNICAL FIELD

The present invention relates to a radial foil bearing with a sealing function.

### BACKGROUND ART

A bearing is largely classified into a rolling bearing (using a ball or a roller), an oilless bearing (using a lubricant material for a frictional operation), a sliding bearing (using an oil), a gas bearing, and a magnetic bearing (using magnetic force for a contactless operation). The sliding bearing is divided into a hydrodynamic sliding bearing and a hydrostatic sliding bearing. The hydrodynamic sliding bearing supports a shaft using an oil pressure generated by a relative sliding motion. The hydrostatic sliding bearing supports a shaft using high-pressure oil supplied from the exterior of the bearing. The gas bearing is operated in the same manner as in the sliding bearing, excepting that gas is substituted for oil. The hydrostatic gas bearing is supplied with a compressed gas from the external source, and the hydrodynamic gas bearing generates the pressure by a relative sliding motion.

The hydrodynamic gas bearing is widely used in the high-speed rotation applications, due to its low friction loss and unnecessity of liquid lubricant. In particular, it is used commonly in case of superspeed applications where the rolling bearing cannot be used for supporting and in case where a liquid lubricant cannot be easily used. The hydrodynamic gas bearing is categorized into a grooved bearing, a tilting pad bearing, and a foil bearing. The grooved bearing has a groove for generating a pressure, and is exemplified by a spiral grooved bearing. In case of the hydrodynamic fluid-film tilt pad bearing, its working condition is very restricted and thus a risk of failure is increased disadvantageously if beyond the working condition. For example, since the rigidity thereof is rapidly decreased when above or below the design criteria, this bearing is very susceptible to impact, misalignment of a shaft, and thermal deformation. In contrast, a foil bearing called “a compliant hydrodynamic fluid-film bearing” provides a very high performance as compared to the fixed-type tilt pad bearing, and a remarkable progress has been made for recent 20 years. In addition, its adequate durability and stability has been confirmed in the air conditioning system for airplanes. In particular, it has been employed in a high-speed rotation machine such as a high-speed cryogenic turbo-compressor of more than 100,000 rpm. This bearing can be used with minute liquid contained therein and its flexibility and the possibility of lower price are their advantages. The foil bearing for airplanes has been used mainly since 1970 in the air cooling machine (ACM), which is a core component for controlling the temperature and pressure inside the cabin in the environmental control system (ESC). This can be considered as a most suitable example of use. In this application, the foil bearing does not contaminate the interior of the cabin because it does not have any oil system. Also, it has enabled a stable operation for a long time, without scheduled maintenance, as compared to a ball bearing. When failed, advantageously it does not lead to the failure of other turbo-components. The foil bearing used in Boeing 747 has been being operated more than 100,000 hours, without any repair.

The foil bearing is roughly divided into two types, i.e., a leaf type and a bump type. As shown in FIG. 1, in the leaf type foil bearing, plural vane-shaped foils are disposed in the direction of rotation with adjacent foils partially overlapped, in which a shaft is to be supported. As shown in FIG. 2, the bump-type foil bearing is provided with a single foil formed in its entirety, and the foil is supported by a spring provided around it. The leaf type foil bearing is suitable to the case where a support load is lower and an external impact is small, and the starting torque thereof is large disadvantageously. In contrast, the bump type brings out a small load when staring, and has a good durability and rigidity. However, since it has a complicated design and production condition, and in particular the stability thereof cannot be easily secured, only 2 or 3 companies hold the technology worldwide. A bearing housing is provided with a bump foil welded to the inner side thereof, and the bump foil serves as a spring. Inwards thereof, a top foil is welded to the bearing housing and the top foil practically abuts against the shaft acting as a journal. When the shaft rotates while drawing the air, the top foil and the bump foil is deformed such that a space for forming a fluid film supporting a load is provided. In the foil bearing, the geometrical structure for forming the fluid film is provided by the elastic deformation of the top foil. As the rotation frequency increase, the top foil and the bump foil are pushed outwards and the shaft is deviated from its center, thereby forming a space having the shape of a converging wedge. At this time, since the foil bearing uses the deforming property of the top foil, an optimum structure capable of generating a suitable dynamic pressure can be designed without any necessity of a complicated machining process. In addition, since a margin is formed in a radial direction, advantageously, it can properly cope with an increase in the shaft diameter due to a high-speed rotation. These characteristics rely upon the thickness of the top foil and the bump structure supporting the top foil. In particular, whether the rigidity and damping required for a shafting can be provided depends on the bump foil design. Therefore, the structure, the thickness, the height, the pitch, the number of the bump foils or the like is critical factors to determine the performance of a bump-type foil bearing.

Furthermore, a military-purpose bearing needs a capability of enduring a higher-speed rotation, and a poor environment and impact. In practice, these requirements for a high speed, high-output and high efficiency BLDC motor cannot be met by a common oil lubricant bearing. In addition, it must endure structurally and adequately a misalignment, heat and vibration. To this end, in order to obtain a maximum supporting power it is known to be beneficial that the bump foil is divided along the axial and rotational direction.

The relevant patent is U.S. Pat. Nos. 4,300,806, 5,915,841, 5,988,885, 4,465,384, 5,498,083, 5,584,582, 6,024,491, 6,190,048B1, 4,624,583, 3,893,733, 3,809,443, 4,178,046, 4,654,939, 4,005,914, 5,911,511, 5,534,723, 5,427,455, and 5,866,518.

The fundamental principle therefor has been patented in 1970s. Modification to the bump and top foils has been made in order to enhance the performance thereof. Much attempt has been made to develop a metallic dry lubricant, which can be applied a high-temperature applications and has a good adhesive property, as disclosed in U.S. Pat. No. 5,866,518.

Furthermore, there have made no endeavors to introduce the foil bearing with a sealing function, but a foil seal has been suggested as a foil bearing type seal. However, the foil seal is just a modified type of the top foil and actually does not function as a bearing.

FIG. 1 shows a conventional leaf type radial foil bearing, and FIG. 2 shows a conventional bump type radial foil bearing wherein the foil bearing has a substantially thick top foil 3. In this case, a fluid may flow to bumps 2 such that a seal should be additionally disposed. Furthermore, the seal has a substantially low performance according to the behaviors of the journal 6.

Therefore, the foil bearing should be hermetically sealed, while only the gap between the journal 6 and the top foil 3 is being left according to the characteristics of the foil bearing, thereby achieving the sealing function.

### DISCLOSURE OF INVENTION

### Technical Problem

Accordingly, it is an object of the present invention to provide a bump-type foil bearing having a combined sealing and bearing function.

### Technical Solution

To achieve the above object, according to the present invention, there is provided a radial foil bearing including: a top foil having the following relationship: t≧0.1·D^{0.33}, where t designates a thickness (mm) and D designates a diameter (mm) of a shaft; and a stopper adapted to prevent the escape of parts of the bearing and to block the gaps formed between adjacent bumps.

### BRIEF DESCRIPTION OF THE DRAWINGS

FIG. 1 shows a conventional leaf type radial foil bearing.

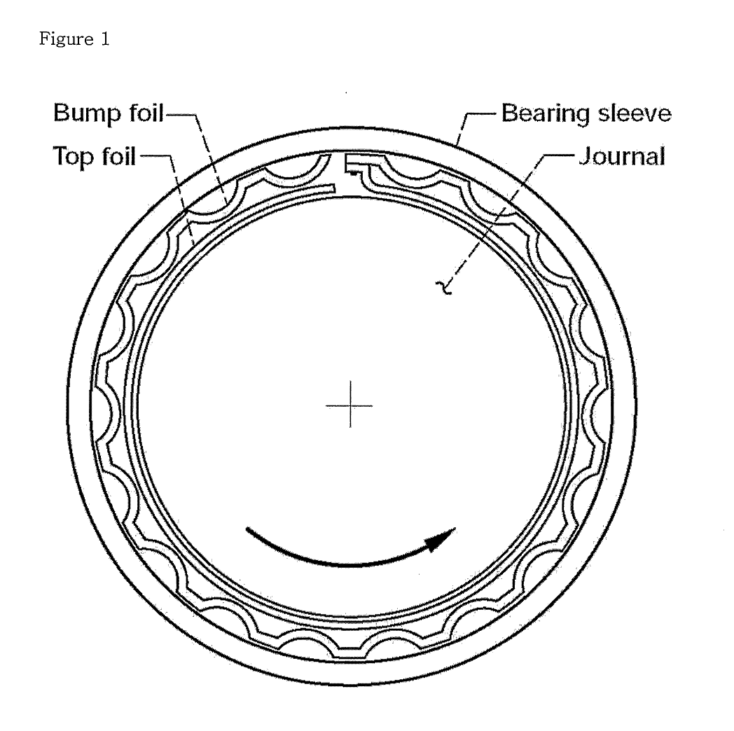

FIG. 2 shows a conventional bump type radial foil bearing wherein the foil bearing has a substantially thick top foil.

FIG. 3 shows a foil bearing with a sealing function according to the present invention.

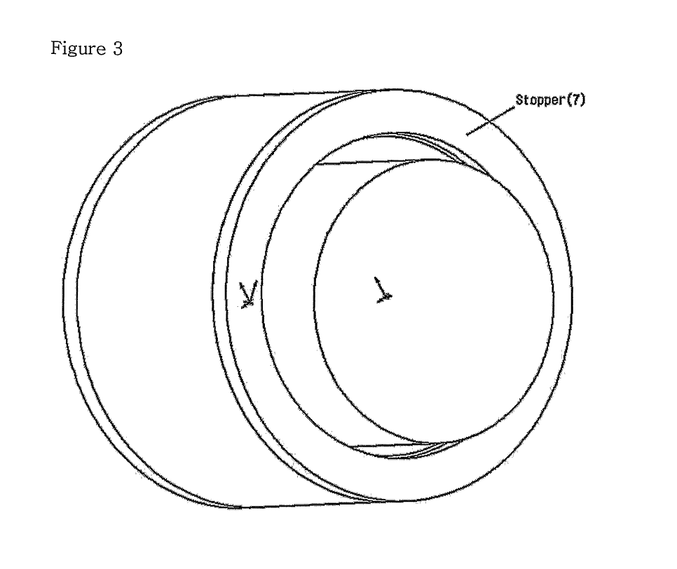

FIG. 4 shows the detailed structure of the foil bearing with a sealing function according to the present invention.

### MODE FOR THE INVENTION

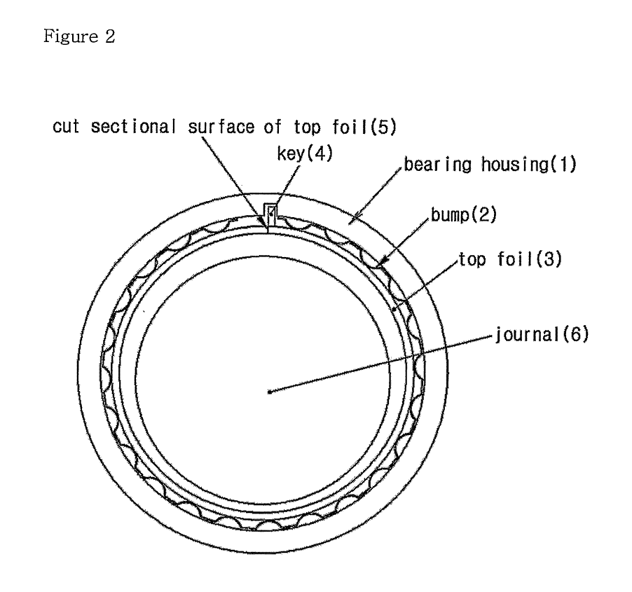

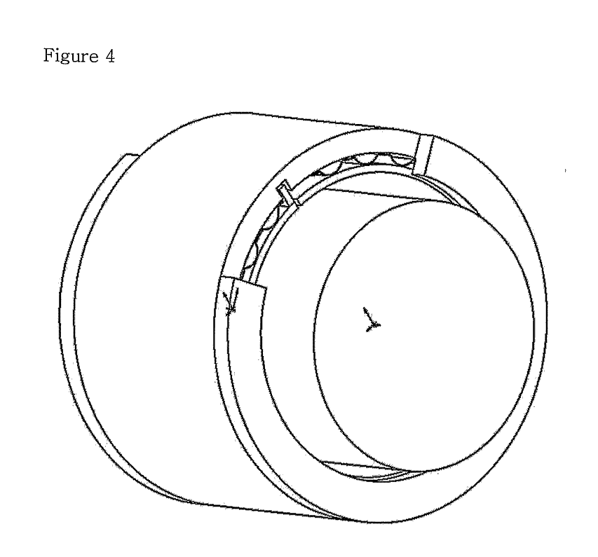

The present invention is applied to the conventional bump type radial foil bearing as shown in FIG. 2, thereby additionally obtaining a sealing function thereto, and as shown in FIG. 4, the fluid-flowing gaps are all removed by using the top foil 3 having a substantially thick thickness machined by means of turning machining, and a stopper 7 adapted to block the gaps formed between adjacent bumps 2, while only a minute gap between the journal 6 and the foil bearing is being left, thereby providing a high sealing performance.

It was therefore found that the substantially thick thickness of the top foil 3 satisfies the following relationship through structural strength and performance tests:

t≧0.1·D^{0.33}

where t designates a thickness (mm) and D designates a diameter (mm) of a shaft.

The inside diameter of the stopper 7 should be set to be larger than the diameter of the journal 6 in consideration of the behaviors of the journal 6. The top foil 3 has heat-expanded space in an axial direction with respect to the stopper 7, thereby performing its function without any interference.

Of course, all kinds of foil bearings have a stopper for preventing the escape of the bearing.

In case of the bearing having a top foil made thick, however, there has been no effort to perform a sealing function by utilizing such a stopper for preventing the escape of the bearing. Moreover, an air foil seal is being separately developed by a world-class company, Miti (http://www.miti.cc) in the industrial fields.

As disclosed in the present invention, therefore, as the stopper is varied in its size to perform a high-performance sealing function, the sealing function can be performed even without any increase in the length of a high-speed shaft by the formation of the seal. As a result, the stability of the shaft can be improved, and a remarkable increase in sealing performance can be also achieved.

### INDUSTRIAL APPLICABILITY

As described above, there is provided a radial foil bearing wherein if the stopper 7 is disposed for blocking the gaps formed between the bumps, only the minute gap remains between the journal 6 and the top foil 3, thereby providing a high sealing efficiency having a minimum gap size.

1. A radial foil bearing comprising:
a top foil (3) having the following relationship:
t≧0.1·D^{0.33}, where t designates a thickness (mm) and D designates a diameter (mm) of a shaft; and
a stopper (7) adapted to prevent the escape of parts of the bearing and to block the gaps formed between adjacent bumps (2).
